(19) United States
(12) Patent Application Publication
(10) Pub. No.: US 2010/0180196 A1
(43) Pub. Date: Jul. 15, 2010

(54) DOCUMENT MANAGEMENT SYSTEM, DOCUMENT MANAGEMENT METHOD, AND DOCUMENT MANAGEMENT PROGRAM EMBODIED ON COMPUTER READABLE MEDIUM

(75) Inventor: Katsuhiko Matsusaka, Itami-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/652,774

(22) Filed: Jan. 6, 2010

(30) Foreign Application Priority Data
Jan. 13, 2009 (JP) 2009-004795

(51) Int. Cl. G06F 17/21

(52) U.S. Cl. 715/255

(57) ABSTRACT

In order to track a page deleted from document data, a PC includes an HDD which stores pieces of document data each including at least one page, a selecting portion to select first document data and second document data from among the stored document data, a moving portion to move at least one of the at least one page included in the first document data into the second document data, and a move destination storing portion to store move destination information, in correspondence with the page that had been included in the first document data before a page move operation and that has been deleted therefrom and added into the second document data as a result of the page move operation, to indicate that the page that had been included in the first document data before movement of the page has been deleted from the first document data and added into the second document data.

This application is based on Japanese Patent Application No. 2009-004795 filed with Japan Patent Office on Jan. 13, 2009, the entire content of which is hereby incorporated by reference.

### BACKGROUND OF THE INVENTION

1. Field of the Invention

The present invention relates to a document management system, a document management method, and a document management program embodied on a computer readable medium. More particularly, the present invention relates to a document management system provided with a function of editing a document on a page basis, and a document management method and a document management program embodied on a computer readable medium which enable editing of a document on a page basis.

2. Description of the Related Art

Recently, a document management system has been established in which a plurality of pieces of document data are stored in a file server or the like to allow a plurality of users to access the plurality of pieces of document data. In this document management system, in the case where a certain user A moves document data to another storage position, in order for another user B to access the document data, the user B needs to be notified by the user A of the storage position in the destination (“move destination”) where the document data is stored, or needs to search the document in the move destination for the storage position of the document data.

Japanese Patent Laid-Open No. 2002-082828 discloses an information management system in which, when a document A stored in a folder A is moved into a folder B as the document A, a document for notification and search of the move destination is automatically generated and registered in the position in the folder A where the document A had been registered. The document for notification and search of the move destination includes: minimum partial information representing the characteristic of the moved document, the move source folder name (i.e., “folder A”), and move destination information necessary for searching the move destination. When an access is made to the document A at the move source, the content of the document for notification and search of the move destination is read out so as to enable search of the move destination of the document A.

Meanwhile, documents may be edited, and a user B may need the content of the document before the same is edited by a user A. According to the conventional information management system, when a document is moved, it is possible to access the document at the move destination. However, in the case where a document A is edited on a page basis and if a page within the document A is moved into another document B, it will be difficult to track the fact that a page has been moved, or, that the page deleted from the original document A has been added into the document B.

### SUMMARY OF THE INVENTION

The present invention has been accomplished in view of the foregoing problems, and an object of the present invention is to provide a document management system, a document management method, and a document management program embodied on a computer readable medium which enable tracking of a page deleted from document data.

Another object of the present invention is to provide a document management system, a document management method, and a document management program embodied on a computer readable medium which can notify a user of a page that has been deleted from document data.

To achieve the above-described objects, according to an aspect of the present invention, a document management system includes: a document data storing portion to store a plurality of pieces of document data each including at least one page; a selecting portion to select first document data and second document data that is different from the first document data from among the plurality of pieces of stored document data; a moving portion to move at least one page among the at least one page included in the selected first document data into the selected second document data; and a move destination storing portion to store move destination information, in correspondence with a page that had been included in the first document data before movement of the page and that has been deleted from the first document data and added into the second document data as a result of the movement of the page, to indicate that the page that had been included in the first document data before movement of the page has been deleted from the first document data and added into the second document data.

According to another aspect of the present invention, a document management system includes: a document data storing portion to store a plurality of pieces of document data each including at least one page; and a document table storing portion to store a plurality of document tables corresponding respectively to the plurality of pieces of stored document data, each document table including page identification information for identifying each of the at least one page that is included in the corresponding document data among the plurality of pieces of stored document data and any page that has been deleted from the document data.

According to a further aspect of the present invention, a document management method includes the steps of: selecting first document data from among a plurality of pieces of stored document data each including at least one page; selecting second document data that is different from the first document data from among the plurality of pieces of stored document data; moving at least one page among the at least one page included in the first document data into the second document data; and storing move destination information, in correspondence with a page that had been included in the first document data before movement of the page and that has been deleted from the first document data and added into the second document data as a result of the movement of the page, to indicate that a page that had been included in the first document data before movement of the page has been deleted from the first document data and added into the second document data.

According to yet another aspect of the present invention, a document management method includes the steps of: storing a plurality of document tables corresponding respectively to a plurality of pieces of stored document data each including at least one page, each document table including page identification information for identifying each of the at least one page that is included in the corresponding document data among the plurality of pieces of stored document data and any page that has been deleted from the document data; and displaying a page deleted from any of the plurality of pieces of document data, on the basis of the plurality of document tables.

According to yet another aspect of the present invention, a document management program embodied on a computer readable medium causes a computer to perform the steps of: selecting first document data from among a plurality of pieces of stored document data each including at least one page; selecting second document data that is different from the first document data from among the plurality of pieces of stored document data; moving at least one page among the at least one page included in the first document data into the second document data; and storing move destination information, in correspondence with a page that had been included in the first document data before movement of the page and that has been deleted from the first document data and added into the second document data as a result of the movement of the page, to indicate that the page that had been included in the first document data before movement of the page has been deleted from the first document data and added into the second document data.

According to a further aspect of the present invention, a document management program embodied on a computer readable medium causes a computer to perform the steps of: storing a plurality of document tables corresponding respectively to a plurality of pieces of stored document data each including at least one page, each document table including page identification information for identifying each of the at least one page that is included in the corresponding document data among the plurality of pieces of stored document data and any page that has been deleted from the document data; and displaying a page deleted from any of the plurality of pieces of document data, on the basis of the plurality of document tables.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing an example of the hardware configuration of a PC according to an embodiment of the present invention.

FIG. 2 is a functional block diagram showing by way of example the functions of a CPU included in the PC.

FIG. 3 shows an example of the format of an associated record.

FIGS. 4A to 4C show examples of document tables.

FIGS. 5A to 5C show examples of the document tables obtained as a result of a first-time page move operation.

FIGS. 6A to 6C show examples of the document tables obtained as a result of a second-time page move operation.

FIG. 7 is a flowchart illustrating an example of the flow of a page editing process.

FIGS. 8 and 9 are flowcharts illustrating an example of the flow of a display process.

FIG. 10 illustrates a page forward button and a page back button.

FIG. 11 shows an example of a specification display.

FIG. 12 shows a first modification of the specification display.

FIG. 13 shows a second modification of the specification display.

FIG. 14 is a flowchart illustrating an example of the flow of a deleting process.

### DESCRIPTION OF THE PREFERRED EMBODIMENTS

Embodiments of the present invention will now be described with reference to the drawings. In the following description, like reference characters denote like parts, which have like names and functions, and therefore, detailed description thereof will not be repeated. In the following, the case of using a personal computer (hereinafter, referred to as a “PC”) as an example of a document management system will be described.

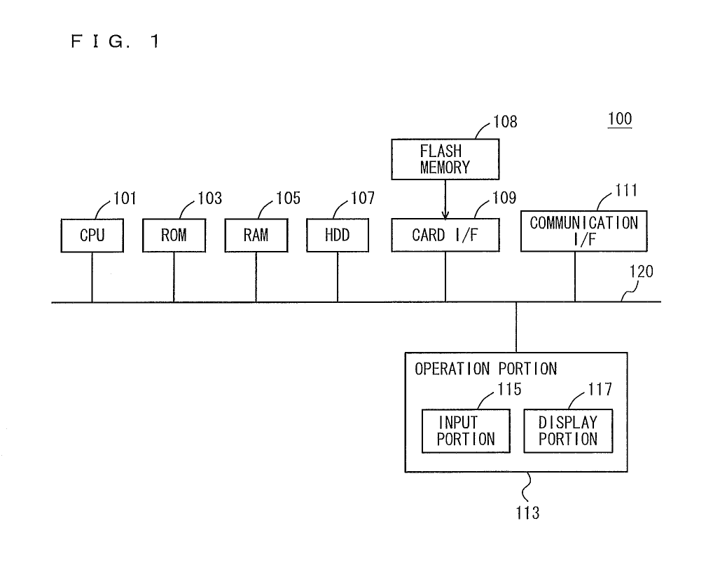

FIG. 1 is a block diagram showing an example of the hardware configuration of a PC according to an embodiment of the present invention. Referring to FIG. 1, a PC 100 includes: a central processing unit (CPU) 101, a read only memory (ROM) 103 which stores therein a program executed by CPU 101 and others, a random access memory (RAM) 105 used as a work area of CPU 101, a hard disk drive (HDD) 107 as a mass storage device, a communication interface (I/F) 111 through which PC 100 is connected to the Internet, an operation portion 113 which functions as an interface with a user, a card interface (I/F) 109 mounted with a flash memory 108, and a bus 120 to which the above elements are connected.

CPU 101 is responsible for overall control of PC 100. CPU 101 executes a document management program stored in ROM 103. Alternatively, CPU 101 may load the document management program stored in flash memory 108 via card I/F 109 into RAM 105 for execution.

Operation portion 113 includes an input portion 115 having a keyboard and a pointing device such as a mouse, and a display portion 117 made up, e.g., of a liquid crystal display for displaying data. Display portion 117 may be an organic electro-luminescence display (ELD), or a cathode-ray tube, instead of the liquid crystal display.

It is noted that the recording medium for storing the program to be executed by CPU 101 is not restricted to flash memory 108. It may be a flexible disk, a cassette tape, an optical disc (compact disc-ROM (CD-ROM), magneto-optical (MO) disc, mini disc (MD), digital versatile disc (DVD)), an IC card, an optical card, or a semiconductor memory such as a mask ROM, an erasable and programmable ROM (EPROM), an electrically erasable and programmable ROM (EEPROM), or the like.

Alternatively, CPU 101 may download the document management program from a computer connected to the Internet and store the same in HDD 107, or a computer connected to the Internet may write the document management program to HDD 107, and thereafter, CPU 101 may execute the program. As used herein, the “document management program” includes, not only the program which CPU 101 can execute directly, but also a source program, a compressed program, an encrypted program, and others.

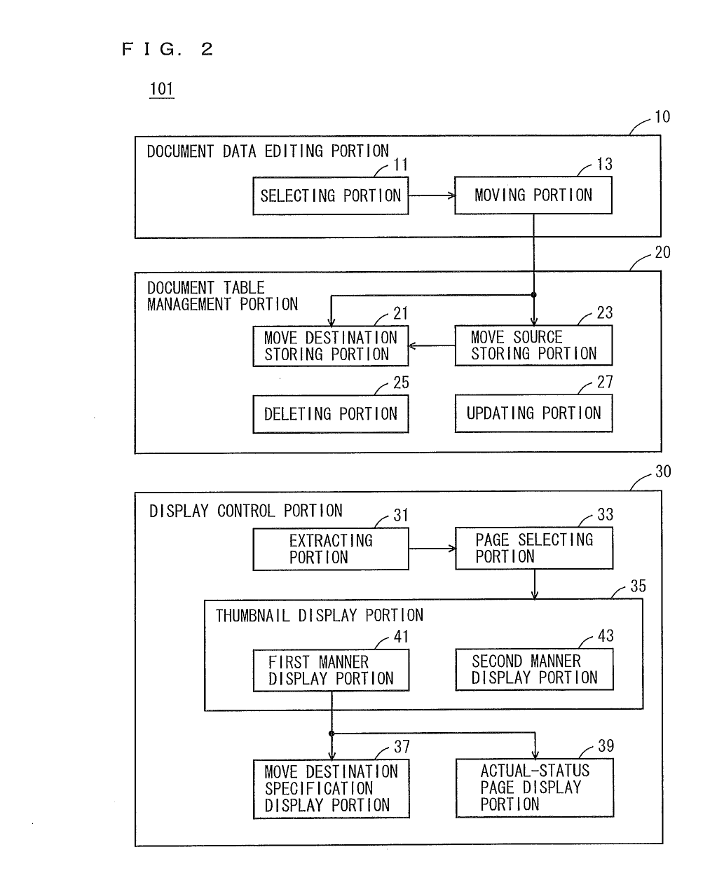

FIG. 2 is a functional block diagram showing by way of example the functions of the CPU included in PC 100. Referring to FIG. 2, CPU 101 includes: a document data editing portion 10 which edits a plurality of pieces of document data stored in HDD 107; a document table management portion 20; and a display control portion 30.

Document data editing portion 10 performs a process of moving a page between two pieces of document data among a plurality of pieces of document data stored in HDD 107. Here, the document data in which the page was originally included (i.e., the move source of the page) is referred to as “first document data”, and the document data to which the page is moved (i.e., the move destination of the page) is referred to as “second document data”. Document data editing portion 10 includes: a selecting portion 11 which selects first document data and second document data as process targets from among the plurality of pieces of document data stored in HDD 107; and a moving portion 13 which moves a page included in the first document data into the second document data.

Selecting portion 11 displays on display portion 117 a plurality of pieces of document identification information for identifying the respective pieces of document data stored in HDD 107. When a user inputs into input portion 115 an instruction to select one of the plurality of pieces of document identification information displayed on display portion 117, selecting portion 11 accepts the instruction to select the document identification information and, in accordance with the accepted instruction, selects the document data specified by the selected document identification information as a process target. Selecting portion 11 outputs the document data selected as the process target, to moving portion 13.

Moving portion 13 deletes a page from within first document data received from selecting portion 11, and adds the page deleted from the first document data into second document data received from selecting portion 11. Specifically, moving portion 13 displays on display portion 117 the first document data input from selecting portion 11, and when the user inputs into input portion 115 an instruction to select a page to be moved, moving portion 13 selects the page specified by the input instruction. Next, moving portion 13 displays on display portion 117 the second document data input from selecting portion 11, and when the user inputs into input portion 115 an instruction to designate the position where the page that had previously been selected as the page to be moved from within the first document data is to be inserted, moving portion 13 inserts the page previously selected as the page to be moved from within the first document data, into the position within the second document data specified by the input instruction, and at the same time, deletes from the first document data the page selected therefrom as the page to be moved. In the case where a plurality of pages are selected as the pages to be moved, the plurality of pages are deleted. Herein, the page number of the page selected by the user from within the first document data as a page to be moved is referred to as the “delete page number”. The position within the second document data designated by the user is represented by one of the page numbers assigned respectively to a plurality of pages included in the second document data, and the page to be moved is inserted just before the page having the designated page number. Herein, the page number representing the position designated by the user within the second document data is referred to as the “insert page number”.

When moving portion 13 moves a page from within the first document data into the second document data, moving portion 13 outputs, to document table management portion 20, document identification information for identifying the first document data, the delete page number, document identification information for identifying the second document data, and the insert page number. In the case where a plurality of pages are selected from within the first document data as the pages to be moved, moving portion 13 outputs to document table management portion 20 a plurality of delete page numbers corresponding respectively to the pages to be moved.

More specifically, assume that the first page in document data A is moved to the second page in document data B. In this case, the first page of document data A is deleted from document data A, and added in between the first page and the second page of document data B. Correspondingly, moving portion 13 outputs, to document table management portion 20, the document identification information for document data A, “1” indicating the first page, the document identification information for document data B, and “2” indicating the second page.

Document table management portion 20 generates a plurality of document tables corresponding respectively to the plurality of pieces of document data stored in HDD 107, and stores the document tables in HDD 107. That is, one document table is generated and stored for one piece of document data. The document table will now be described.

A document table includes associated records for defining virtual pages. The document table includes the associated records of the same number as that of the virtual pages defined in the document table. There is one virtual page for each of the pages that are actually included in document data corresponding to that document table, and there is also one virtual page for each of the pages that have been deleted from the document data corresponding to that document table. In other words, the document table includes the associated records which define the virtual pages corresponding to the pages which are actually included in the document data, and the associated records which define the virtual pages corresponding to the pages which have been deleted from the document data.

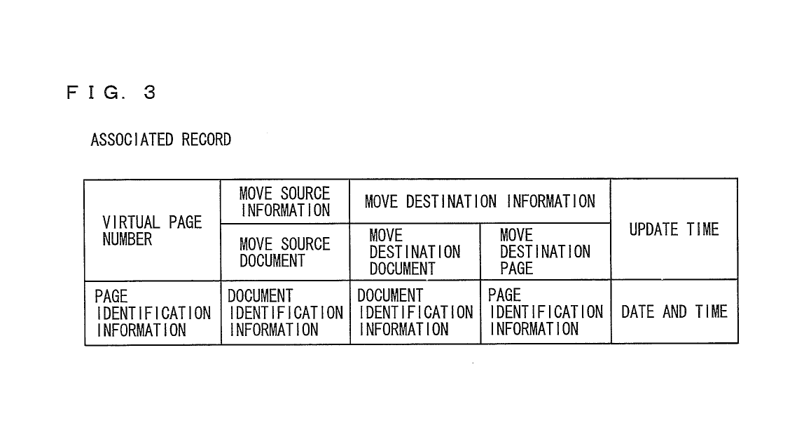

FIG. 3 shows an example of the format of an associated record. Referring to FIG. 3, an associated record includes the fields of: “virtual page number”, “move source information”, “move destination information”, and “update time”. In the “virtual page number” field, page identification information for identifying a virtual page is set. In the case where no page has been deleted from the document data corresponding to the document table, the page identification information for the virtual page coincides with the page number of the corresponding page within the document data.

The “move source information” field includes the field of “move source document”. In the case where the page within the document data corresponding to the virtual page is the one that has been added into the document data as a result of a page move operation, then the document identification information for identifying the document data in which the page had been included before the page move operation is set in the “move source document” field. The “move destination information” field includes the fields of “move destination document” and “move destination page”. In the case where the page within the document data corresponding to the virtual page is the one that had been included in the document data before a page move operation but has been deleted therefrom as a result of the page move operation, then the document identification information for identifying the document data into which the page is added as a result of the page move operation is set in the “move destination document” field. Also in the case where the page within the document data corresponding to the virtual page is the one that had been included in the document data before a page move operation but has been deleted therefrom as a result of the page move operation, page identification information which is assigned to that page in a document table corresponding to the document data into which the page is added as a result of the page move operation is set in the “move destination page” field.

In the “update time” field, the date and time when the “move source information” or “move destination information” field was updated is set. The date and time includes year, month, day, hour, and minute.

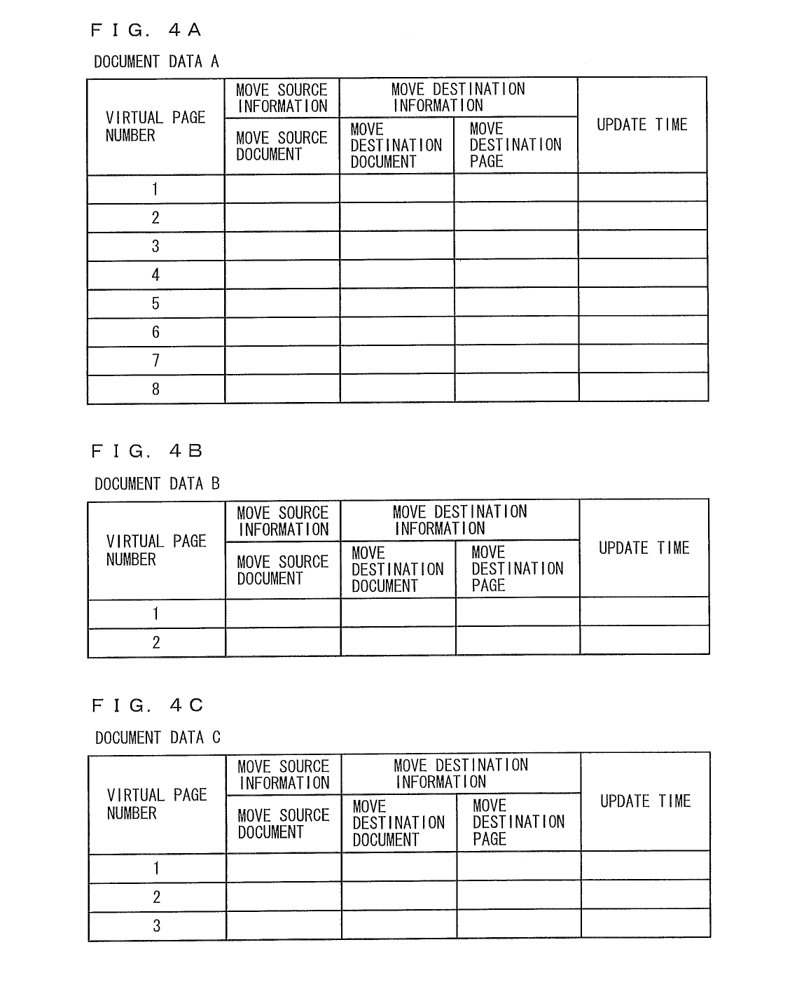

FIGS. 4A to 4C show examples of document tables. FIGS. 4A, 4B, and 4C show document tables corresponding to document data A, document data B, and document data C, respectively.

FIG. 4A shows a document table which is generated in the case where none of eight pages included in document data A has been moved, i.e., no page has been deleted from or added to document data A. The document table for document data A includes eight associated records to which the virtual page numbers “1” to “8” have been assigned respectively. In all of the eight associated records, the “move source information” field and the “move destination information” field are left blank. FIG. 4B shows a document table which is generated in the case where neither of two pages included in document data B has been moved, i.e., no page has been deleted from or added to document data B. The document table for document data B includes two associated records to which the virtual page numbers “1” and “2” have been assigned respectively. In both of the two associated records, the “move source information” field and the “move destination information” field are left blank. FIG. 4C shows a document table which is generated in the case where none of three pages included in document data C has been moved, i.e., no page has been deleted from or added to document data C. The document table for document data C includes three associated records to which the virtual page numbers “1” to “3” have been assigned respectively. In all of the three associated records, the “move source information” field and the “move destination information” field are left blank.

Returning to FIG. 2, document table management portion 20 includes a move destination storing portion 21, a move source storing portion 23, a deleting portion 25, and an updating portion 27.

Move source storing portion 23 receives, from document data editing portion 10, the document identification information for identifying the first document data, the document identification information for identifying the second document data, and the insert page number. Move source storing portion 23 reads a document table corresponding to the document data specified by the document identification information for identifying the second document data, and generates a new associated record including new page identification information corresponding to the insert page number. The new page identification information is determined as follows. The number of associated records in which the “move destination information” field is left blank is counted from the one having the page identification information of “1”, and the page identification information corresponding to the time when the count has become equal to the insert page number is determined as the new page identification information. Move source storing portion 23 outputs the new page identification information to move destination storing portion 21. Then, move source storing portion 23 sets the document identification information for identifying the first document data into the “move source document” field included in the “move source information” field in the newly generated associated record, and stores the new associated record in the document table. Thereafter, move source storing portion 23 refers to the associated records that have been included in the document table before the addition of the new associated record and, for any of those associated records whose page identification information has a value equal to or greater than that of the new page identification information, updates the page identification information by incrementing the value by one. Furthermore, move source storing portion 23 sets the current date and time in the “update time” field in the newly added associated record.

Move destination storing portion 21 receives the document identification information for identifying the first document data, the delete page number, and the document identification information for identifying the second document data from document data editing portion 10, and receives the new page identification information from move source storing portion 23. Move destination storing portion 21 reads a document table corresponding to the document data specified by the document identification information for identifying the first document data, and extracts the associated record that includes the page identification information corresponding to the delete page number. In order to obtain the page identification information corresponding to the delete page number, the number of associated records in which the “move destination information” field is left blank is counted from the one having the page identification information of “1”, and the page identification information corresponding to the time when the count has become equal to the delete page number is obtained as the page identification information corresponding to the delete page number. Then, for the extracted associated record, move destination storing portion 21 sets the document identification information for identifying the second document data in the “move destination document” field and sets the new page identification information received from move source storing portion 23 in the “move destination page” field in the “move destination information” field. Furthermore, move destination storing portion 21 sets the current date and time in the “update time” field in the extracted associated record.

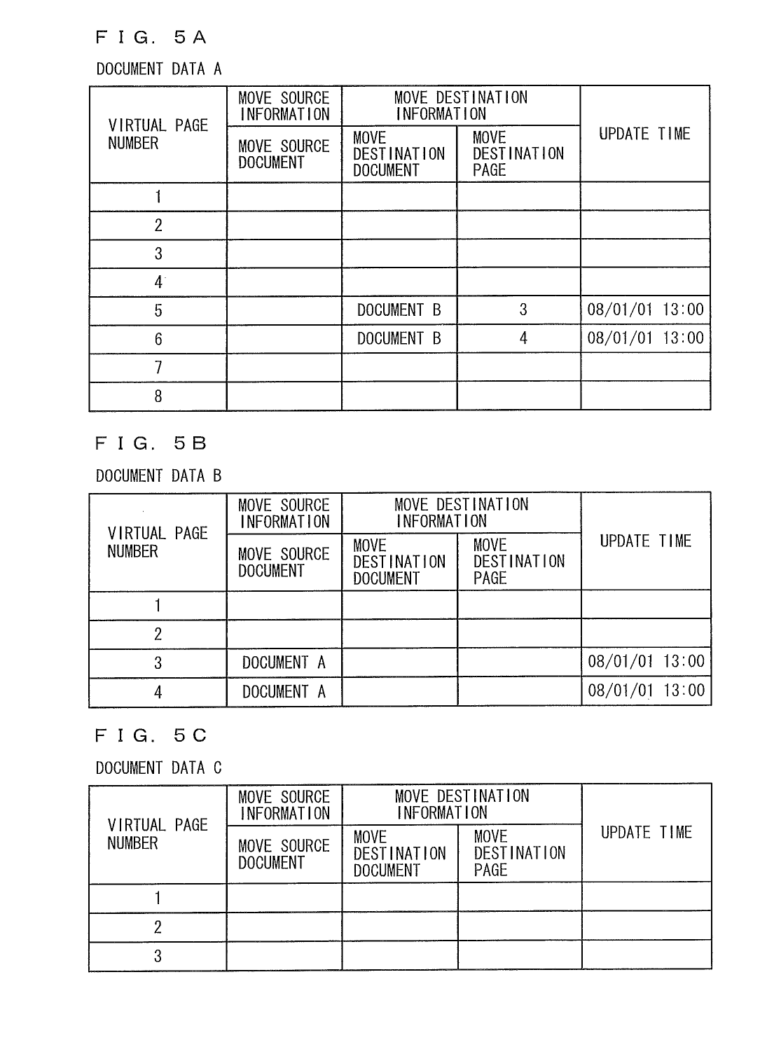

FIG. 5A shows, by way of example, the document table corresponding to document data A obtained as a result of a first-time page move operation, FIG. 5B shows, by way of example, the document table corresponding to document data B obtained as a result of the first-time page move operation, and FIG. 5C shows, by way or example, the document table corresponding to document data C obtained as a result of the first-time page move operation. Referring to FIGS. 5A and 5B, the case where the fifth and sixth pages in document data A are added into the third and fourth pages, respectively, in document data B is shown. In document data A, the page identification information corresponding to the fifth page is “5” and the page identification information corresponding to the sixth page is “6”. Now, the fifth and sixth pages in document data A are to be added as the third and fourth pages, respectively, in document data B. In document data B, the page identification information corresponding to the third page is “3”, and the page identification information corresponding to the fourth page is “4”.

Firstly, the case where the fifth page in document data A is moved to the third page in document data B will be described. In the document table for document data B shown in FIG. 5B, a new associated record is generated, and new page identification information “3” corresponding to the added page is set in the “virtual page number” field in that associated record. The new associated record is added into the document table for document data B. Then, in the added associated record, the document identification information “document A” for identifying document data A is set in the “move source document” field. Furthermore, in the document table for document data A shown in FIG. 5A, in consideration of the fact that the page identification information corresponding to the fifth page in document data A is “5”, the associated record having the page identification information “5” set in the “virtual page number” field is selected. Then, in the “move destination information” field in the selected associated record, the document identification information “document B” for identifying document data B is set in the “move destination document” field and the new page identification information “3”, which has been assigned to the page added into document data B in the document table for document data B shown in FIG. 5B, is set in the “move destination page” field.

The document identification information and the page identification information set in the “move destination information” field in the associated record that is included in the document table for document data A and that has the page identification information “5” set in the “virtual page number” field constitute the “move destination information” of the present invention. The move destination information is associated with the page that had been included in document data A before movement of the page and that has been deleted from document data A and added into document data B as a result of the movement of the page, and it indicates that the page that had been included in document data A before movement of the page has been deleted from document data A and added into document data B. Furthermore, the document identification information set in the “move source information” field in the associated record that is included in the document table for document data B and that has the page identification information “3” set in the “virtual page number” field constitutes the “move source information” of the present invention. The move source information is associated with the page that had not been included in document data B before movement of the page and that has been added thereto from document data A as a result of the movement of the page, and it indicates that the page has been added from document data A as a result of the movement of the page.

Now, the case where the sixth page in document data A is moved to the fourth page in document data B will be described. In the document table for document data B shown in FIG. 5B, a new associated record is generated, and new page identification information “4” corresponding to the added page is set in the “virtual page number” field in that associated record. The new associated record is added into the document table for document data B. Then, in the added associated record, the document identification information “document A” for identifying document data A is set in the “move source document” field. Furthermore, in the document table for document data A shown in FIG. 5A, in consideration of the fact that the page identification information corresponding to the sixth page in document data A is “6”, the associated record having the page identification information “6” set in the “virtual page number” field is selected. Then, in the “move destination information” field in the selected associated record, the document identification information “document B” for identifying document data B is set in the “move destination document” field and the new page identification information “4”, which has been assigned to the page added into document data B in the document table for document data B shown in FIG. 5B, is set in the “move destination page” field.

The document identification information and the page identification information set in the “move destination information” field in the associated record that is included in the document table for document data A and that has the page identification information “6” set in the “virtual page number” field constitute the “move destination information” of the present invention. The move destination information is associated with the page that had been included in document data A before movement of the page and that has been deleted from document data A and added into document data B as a result of the movement of the page, and it indicates that the page that had been included in document data A before movement of the page has been deleted from document data A and added into document data B. Furthermore, the document identification information set in the “move source information” field in the associated record that is included in the document table for document data B and that has the page identification information “4” set in the “virtual page number” field constitutes the “move source information” of the present invention. The move source information is associated with the page that had not been included in document data B before movement of the page and that has been added thereto from document data A as a result of the movement of the page, and it indicates that the page has been added from document data A as a result of the movement of the page.

As a result, in the document table for document data A, the associated record having the page identification information “7” set in the “virtual page number” field corresponds to the fifth page in document data A, and the associated record having the page identification information “8” set in the “virtual page number” field corresponds to the sixth page in document data A.

Referring to FIG. 5C, no page has been deleted from or added to document data C, and accordingly, the document table for document data C shown in FIG. 5C is identical to that shown in FIG. 4C.

Deleting portion 25 sequentially reads the document tables stored in HDD 107 for execution of a deleting process. The deleting process is carried out periodically. Specifically, deleting portion 25 extracts, from the document tables, any associated record in which the date and time that has been set in the “update time” field indicates a predetermined time before the current date and time, and sets the field of “move source information” or “move destination information” in the extracted associated record to blank, to thereby delete the move destination information or the move source information from the associated record. In other words, the values which are set in the “move destination information” field and the “move source information” field are each deleted from the associated record after a lapse of a predetermined time from the date and time when the value was set.

Furthermore, deleting portion 25 deletes the move destination information set in the “move destination information” field in response to the event that the page specified by the move destination information is erased. Specifically, when a page included in certain document data is deleted, deleting portion 25 refers to an associated record corresponding to the deleted page that is included in the document table for that document data, to specify document data from which the page had been moved, on the basis of the document identification information set in the “move source information” field in that associated record. Then, from the associated records included in the document table for the document data specified as the move source of the page, deleting portion 25 extracts the associated record in which the document identification information for identifying the document data from which the page was deleted is set in the “move destination document” field and the page identification information for identifying the deleted page is set in the “move destination page” field. Deleting portion 25 then sets the “move destination document” field and the “move destination page” field in the extracted associated record to blank, to thereby delete the move destination information from the associated record. It is noted that the page deletion herein includes, not only the case where the page is actually deleted from HDD 107 included in PC 100 serving as the document management system, but also the case where the page is kept in HDD 107 but excluded from the target of management.

Updating portion 27 updates page identification information set in the “move destination page” field. Specifically, assume that the page identification information for the page which is specified by the document identification information set in the “move destination document” field and the page identification information set in the “move destination page” field in the associated record is changed in the document table corresponding to the document data which is specified by the document identification information set in the “move destination document” field. In response thereto, updating portion 27 updates the page identification information set in the “move destination page” field with the changed page identification information. More specifically, in the case where a page is added to document data (e.g., “document data B”), the pages following the added page have their page numbers changed, and correspondingly, the page identification information in the associated records included in the document table for document data B are changed. Among those associated records having the page identification information changed, if there is any associated record in which the “move source information” field is not blank, updating portion 27 extracts a document table corresponding to the document data (e.g., “document data A”) specified by the document identification information set in the “move source information” field in that associated record. Updating portion 27 then extracts, from the associated records included in the extracted document table corresponding to document data A, any associated record in which the document identification information for document data B to which the page has been added is set in the “move destination document” field and the page identification information before being changed in the document table for document data B is set in the “move destination page” field. Updating portion 27 updates the page identification information set in the “move destination page” field in the extracted associated record with the page identification information after being changed in the document table for document data B.

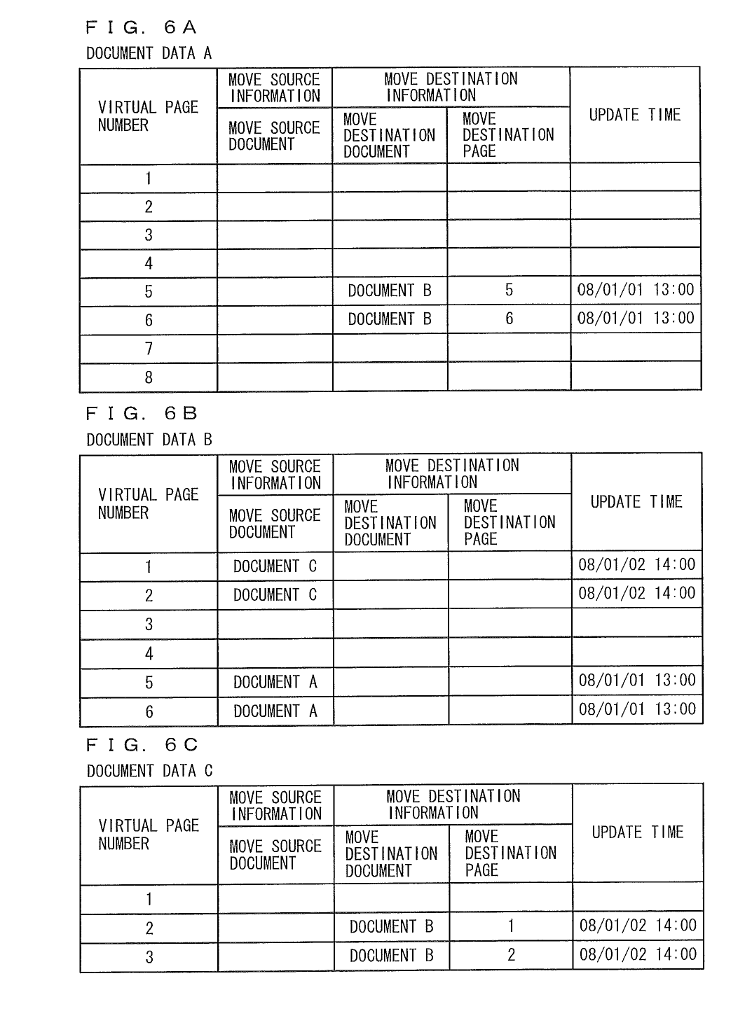

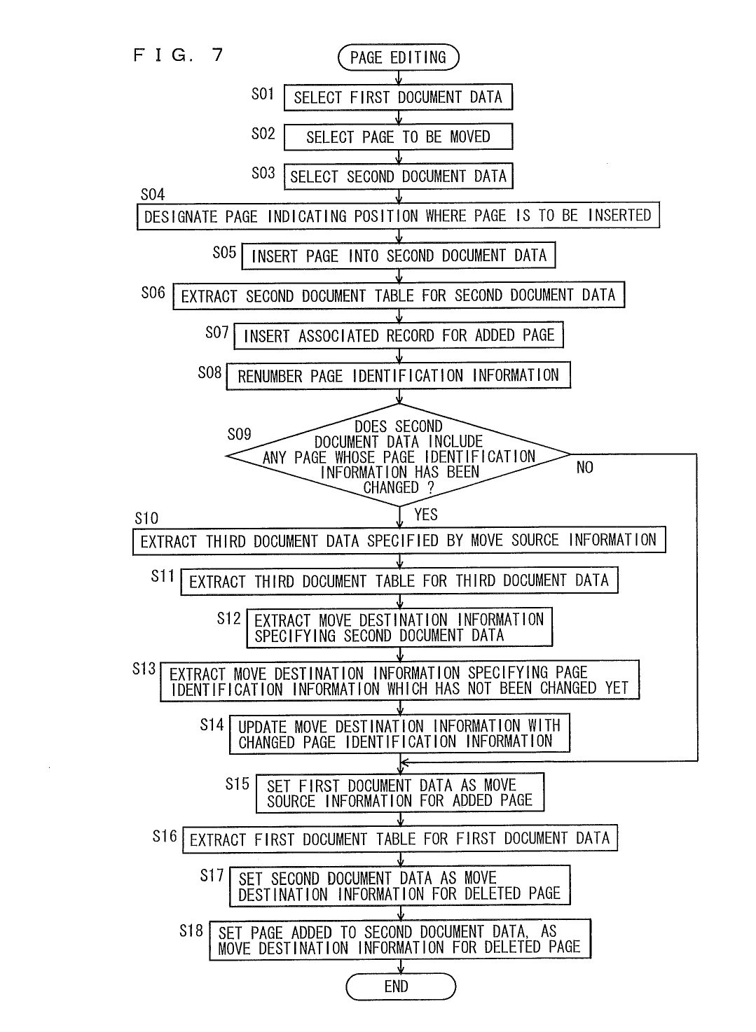

FIG. 6A shows, by way of example, the document table corresponding to document data A obtained as a result of a second-time page move operation, FIG. 6B shows, by way of example, the document table corresponding to document data B obtained as a result of the second-time page move operation, and FIG. 6C shows, by way of example, the document table corresponding to document data C obtained as a result of the second-time page move operation. Here, the case where the second and third pages in document data C are moved to the first and second pages, respectively, in document data B is shown. Referring to FIG. 5C, before the page move operation, the page identification information corresponding to the second page in document data C is “2” and the page identification information corresponding to the third page therein is “3”. Now, the second and third pages in document data C are to be added as the first and second pages, respectively, in document data B. Referring to FIG. 5B, before the page move operation, the page identification information corresponding to the first page in document data B is “1”, and the page identification information corresponding to the second page therein is “2”.

Firstly, the case where the second page in document data C is moved to the first page in document data B will be described. In the document table for document data C shown in FIG. 6C, the page identification information corresponding to the second page in document data C is “2”. Therefore, in the associated record having the page identification information “2” set in the “virtual page number” field, the document identification information “document B” for identifying document data B is set in the “move destination document” field, and new page identification information “1”, which is to be assigned to the page added into document data B in the document table for document data B shown in FIG. 6B, is set in the “move destination page” field. Furthermore, in the document table for document data B shown in FIG. 6B, a new associated record is generated, and the new page identification information “1” corresponding to the added page is set in the “virtual page number” field in that associated record. The new associated record is added into the document table for document data B. Then, in the added associated record, the document identification information “document C” for identifying document data C is set in the “move source document” field.

Now, the case where the third page in document data C is moved to the second page in document data B will be described. In the document table for document data C shown in FIG. 6C, the page identification information corresponding to the third page in document data C is “3”. Therefore, in the associated record having the page identification information “3” set in the “virtual page number” field, the document identification information “document B” for identifying document data B is set in the “move destination document” field, and new page identification information “2”, which is to be assigned to the page added into document data B in the document table for document data B shown in FIG. 6B, is set in the “move destination page” field. Furthermore, in the document table for document data B shown in FIG. 6B, a new associated record is generated, and the new page identification information “2” corresponding to the added page is set in the “virtual page number” field in that associated record. The new associated record is added into the document table for document data B. Then, in the added associated record, the document identification information “document C” for identifying document data C is set in the “move source document” field.

Furthermore, in the document table for document data B, the page identification information set as the virtual page numbers are renumbered. As a result, the page identification information “1” to “4” that have been set before the page move operation are changed to “3” to “6”, respectively. Then, from the associated records having the page identification information changed, any associated record in which the “move source document” field is not blank is extracted. Here, the associated record having the page identification information “5” set in the “virtual page number” field and the associated record having the page identification information “6” set in that field are extracted. Now, the updating process for the associated record having the page identification information “5” set in the “virtual page number” field in the document table for document data B will be described. Firstly, on the basis of the document identification information (here, “document A”) set in the “move source information” field in the extracted associated record, the document table corresponding to document data A specified by the document identification information is extracted. Then, from the associated records included in the extracted document table for document data A, the associated record in which the document identification information “document B” for identifying document data B to which the page has been added is set in the “move destination document” field and the page identification information before being changed (here, “3”) is set in the “move destination page” field is extracted (see FIG. 5A). As a result, the associated record having the page identification information “5” set in the “virtual page number” field is extracted from the document table for document data A shown in FIG. 5A. Then, as shown in FIG. 6A, the page identification information before being changed, “3”, set in the “move destination page” field in the extracted associated record is updated with the changed page identification information “5”.

Next, the updating process for the associated record having “6” set in the “virtual page number” field in the document table for document data B will be described. Firstly, on the basis of the document identification information (here, “document A”) set in the “move source information” field in the extracted associated record, the document table corresponding to document data A specified by the document identification information is extracted. Then, from the associated records included in the extracted document table for document data A, the associated record in which the document identification information “document B” for identifying document data B to which the page has been added is set in the “move destination document” field and the page identification information before being changed (here, “4”) is set in the “move destination page” field is extracted (see FIG. 5A). As a result, the associated record having “6” set in the “virtual page number” field is extracted from the document table for document data A shown in FIG. 5A. Then, as shown in FIG. 6A, the page identification information before being changed, “4”, set in the “move destination page” field in the extracted associated record is updated with the changed page identification information “6”.

Returning to FIG. 2, display control portion 30 displays a plurality of pieces of document data stored in HDD 107 on the basis of the plurality of document tables stored in HDD 107 in correspondence with the respective pieces of document data. Display control portion 30 includes: an extracting portion 31, a page selecting portion 33, a thumbnail display portion 35, a move destination specification display portion 37, and an actual-status page display portion 39.

Extracting portion 31 extracts one of the plurality of pieces of document data stored in HDD 107, and outputs the document identification information for the extracted document data to page selecting portion 33. For example in the case where a user inputs into input portion 115 an instruction to display a list of all the document data within a folder, extracting portion 31 sequentially selects the plurality of pieces of document data stored in the folder, and outputs the document identification information for the selected document data to page selecting portion 33.

Page selecting portion 33 reads from HDD 107 a document table corresponding to the document data specified by the document identification information received from extracting portion 31, selects page identification information, and outputs to thumbnail display portion 35 an associated record in which the selected page identification information is set in the “virtual page number” field. Specifically, page selecting portion 33 firstly selects the page identification information “1”, and outputs the associated record having “1” set in the “virtual page number” field to thumbnail display portion 35. When the user inputs a page forward instruction into input portion 115, page selecting portion 33 selects the page identification information for the succeeding page. When the user inputs a page back instruction into input portion 115, page selecting portion 33 selects the page identification information for the preceding page.

Thumbnail display portion 35, on the basis of the associated record input from page selecting portion 33, displays on display portion 117 a thumbnail image which is an image reduced in size of the page that is specified by the page identification information set in the “virtual page number” field in the associated record. Specifically, when the “move destination information” field in the associated record is left blank, the page corresponding to that page identification information is included in the document data corresponding to the document table in which the associated record is included. Thus, the page number in the document data is determined on the basis of the page identification information. For determining the page number, the number of associated records in which the page identification information smaller in value than the relevant page identification information is set in the “virtual page number” field and in which the “move destination information” field is left blank is counted.

For example, assume that document data A is extracted by extracting portion 31, and the document table for document data A shown in FIG. 5A is extracted and the page identification information “7” is selected by page selecting portion 33. In the associated record having the page identification information “7” set in the “virtual page number” field, the “move destination information” field is left blank. In this case, the page identification information smaller in value than the page identification information “7” are “1” to “6”, and among the associated records having “1” to “6” respectively set in the “virtual page number” field, four associated records with the page identification information “1” to “4” each have the “move destination information” field that is left blank. Therefore, it is determined that the page number of the page within document data A corresponding to the page identification information “7” is “5”.

Thumbnail display portion 35 extracts, from the document data, a thumbnail image which is an image reduced in size of the page within the document data specified by the determined page number. Here, the thumbnail image for the page having the page number “5” in document data A is extracted from document data A.

On the other hand, in the associated record having the selected page identification information set in the “virtual page number” field, if the “move destination information” field is not blank, the page specified by the selected page identification information has been moved to another document data. Therefore, the thumbnail image is acquired on the basis of the document identification information that is set in the “move destination document” field and the page identification information that is set in the “move destination page” field in the “move destination information” field in the associated record. Specifically, the document table corresponding to the document data specified by the document identification information set in the “move destination document” field is acquired and, from the acquired document table, the associated record in which the page identification information that is set in the “move destination page” field is set in the “virtual page number” field is extracted.

When the “move destination information” field in the extracted associated record is left blank, the page corresponding to the page identification information set in the “virtual page number” field in the extracted associated record is included in the document data specified by the document identification information set in the “move destination document” field. Thus, the page number of that page within the document data is determined on the basis of the page identification information that is set in the “virtual page number” field in the extracted associated record. For determining the page number, the number of associated records in which the page identification information smaller in value than the relevant page identification information is set in the “virtual page number” field and in which the “move destination information” field is left blank is counted.

For example, assume that document data A is extracted by page selecting portion 33, and the document table for document data A shown in FIG. 5A is extracted and the page identification information “5” is selected. In this case, in the associated record having the page identification information “5” set in the “virtual page number” field, the “move destination information” field is not blank. Therefore, the document identification information “document B” set in the “move destination document” field and the page identification information “3” set in the “move destination page” field in that associated record are extracted.

Then, the document table (FIG. 5B) corresponding to document data B specified by the document identification information “document B” set in the “move destination document” field is acquired and, from the acquired document table, the associated record in which the page identification information “3” set in the “move destination page” field is set in the “virtual page number” field is extracted. As a result, the associated record having the page identification information “3” set in the “virtual page number” field is extracted. Furthermore, in the extracted associated record, the “move destination information” field is left blank, which means that the page corresponding to the page identification information “3” is included in document data B. Therefore, it is determined that the page number of the page within document data B corresponding to the page identification information “3” is “3”.

Thumbnail display portion 35 extracts from the document data the thumbnail image which is an image reduced in size of the page in the document data that is specified by the determined page number. Here, the thumbnail image for the page having the page number “3” in document data B is extracted from document data B.

Thumbnail display portion 35 includes a first manner display portion 41 and a second manner display portion 43. First manner display portion 41 displays on display portion 117 a thumbnail image for an extracted page in a first display manner in the case where the “move destination information” field in the corresponding associated record is not blank. On the other hand, second manner display portion 43 displays on display portion 117 a thumbnail image for an extracted page in a second display manner in the case where the “move destination information” field in the corresponding associated record is left blank. Here, the first display manner is lower in brightness than the second display manner.

Move destination specification display portion 37 displays on display portion 117 a specification display for specifying document data in which a page corresponding to the thumbnail image displayed in the first display manner is stored, in response to the event that a user inputs an instruction to display a specification display for that thumbnail image displayed in the first display manner. The specification display instruction may be input, for example, by a single-click operation performed in the state where the mouse pointer is placed on the thumbnail image. The specification display may be, for example, a display on display portion 117 of the document identification information for identifying the document data in which the page corresponding to the displayed thumbnail image is included, or a display on display portion 117 of an arrow which extends from the displayed thumbnail image toward a thumbnail image for the document data in which the page corresponding to the displayed thumbnail image is included.

Actual-status page display portion 39 displays on display portion 117 an actual status of the page corresponding to the thumbnail image displayed in the first display manner, in response to the event that the user inputs an instruction to display an actual status of the page for that thumbnail image displayed in the first display manner. The actual-status page display instruction may be input, for example, by a double-click operation performed in the state where the mouse pointer is placed on the thumbnail image. Specifically, the document data including the page corresponding to the thumbnail image being displayed in the first display manner is read from HDD 107, and the page corresponding to that thumbnail image is displayed. For example, in the state where the document tables shown in FIGS. 5A, 5B, and 5C are stored in HDD 107, when the page identification information “5” in document data A is selected, the thumbnail image corresponding to the third page in document data B is displayed in the first display manner. When the user inputs an actual-status page display instruction for this thumbnail image, actual-status page display portion 39 reads document data B, and displays the third page on display portion 117.

FIG. 7 is a flowchart illustrating an example of the flow of a page editing process. The page editing process is carried out by CPU 101 as CPU 101 executes a document management program. Referring to FIG. 7, CPU 101 extracts one of a plurality of pieces of document data stored in HDD 107 as first document data (step S01). For example, CPU 101 displays on display portion 117 a plurality of pieces of document identification information for identifying the respective ones of the document data stored in HDD 107, and when a user inputs into input portion 115 an instruction to select one of the plurality of pieces of document identification information displayed on display portion 117, CPU 101 accepts the instruction to select the document identification information and, in accordance with the accepted instruction, selects the document data specified by the selected document identification information as the first document data.

CPU 101 then selects at least one page from among at least one page included in the first document data as a page to be moved (step S02). Specifically, CPU 101 displays the first document data on display portion 117, and when the user inputs into input portion 115 an instruction to select a page to be moved, CPU 101 selects the page specified by the input instruction.

Next, CPU 101 extracts another one of the plurality of pieces of document data stored in HDD 107 as second document data (step S03). Then, in order for the page selected in step S02 to be inserted into the second document data, CPU 101 selects a page, in the second document data, indicating the position where the page is to be inserted (step S04). Specifically, CPU 101 displays the second document data on display portion 117, and when the user inputs into input portion 115 an instruction to select a page that will immediately follow the page when the same is inserted, CPU 101 selects the page specified by the input instruction as the page indicating the position where the page is to be inserted.

In step S05, the page selected in step S02 is inserted just before the page designated in step S04. Specifically, the page selected in step S02 is added in front of the page designated in the second document data, and the page selected in step S02 is deleted from the first document data.

In step S06, a second document table corresponding to the second document data is extracted from HDD 107. Then, an associated record for the page added into the second document data in step S05 is generated, and the generated associated record is inserted into the second document table (step 507).

In the generated associated record, the page identification information identical to the page identification information that is set in the “virtual page number” field in the associated record corresponding to the page designated in step S04 is set in the “virtual page number” field. At this stage, the “move source information” field and the “move destination information” field in the associated record are blank. Then, in the following step S08, the page identification information is renumbered. Specifically, in each of all the associated records corresponding respectively to the pages following the page designated in step S04, the page identification information set in the “virtual page number” field is changed to the value incremented by one.

In step S09, it is determined whether the second document data includes any page for which the page identification information has been changed. Specifically, of the plurality of associated records included in the second document table corresponding to the second document data, the associated records having the page identification information changed are extracted. Here, the associated records corresponding respectively to all the pages following the page designated in step S04 are extracted. Then, from the extracted associated records, any associated record in which the “move source information” field is not blank is extracted.

In the following step S10, the document data specified by the move source information is extracted. Specifically, by referring to the associated record extracted in step 509, the data that is specified by the document identification information set in the “move source information” field in that associated record is extracted. Then, in correspondence with the extracted document data, which is here the third document data, a third document table corresponding to the third document data is extracted from HDD 107 (step S11).

Next, from the third document table extracted in step S11, the move destination information specifying the second document data is extracted (step S12). Specifically, from a plurality of associated records included in the third document table, any associated record in which the document identification information for identifying the second document data is set in the “move destination document” field in the “move destination information” field (i.e., the move destination information specifying the second document data) is extracted. Then, from among the move destination information specifying the second document data, the move destination information that specifies the page identification information before being renumbered in step S08 in the document table corresponding to the second document data is extracted (step S13). Specifically, from the associated records, extracted in step S12, having the document identification information for identifying the second document data set in the “move destination document” field, any associated record in which the page identification information before being changed is set in the “move destination page” field is extracted. Then, the move destination information in the extracted associated record is updated with the changed page identification information (step S14). Specifically, in the associated record extracted in step S13, the value set in the “move destination page” field is updated with the page identification information changed as a result of renumbering in step S08.

As described above, when a page is inserted into the second document data, in the second document table corresponding to the second document data, the page identification information is changed for each of the pages following the inserted page. Correspondingly, in the third document table, in any associated record in which the document identification information for identifying the second document data is set in the “move destination document” field and the page identification information before being changed is set in the “move destination page” field, the page identification information set in the “move destination page” field is updated to the page identification information changed in the second document table.

In step S15, the first document data is set as the move source information for the page added into the second document data. Specifically, in the associated record newly generated and added to the second document table in step S07, the document identification information for the first document data is set in the “move source document” field.

Next, a first document table corresponding to the first document data is extracted from HDD 107 (step S16). Then, the second document data is set as the move destination information for the deleted page (step S17). Specifically, among a plurality of associated records included in the first document table extracted in step S16, in the associated record in which the page identification information corresponding to the deleted page is set in the “virtual page number” field (i.e., in the move destination information for the deleted page), the document identification information for the second document data is set in the “move destination document” field.

In step S18, the page added into the second document data is set as the move destination information for the deleted page. Specifically, among the plurality of associated records included in the first document table extracted in step S16, in the associated record in which the page identification information corresponding to the deleted page is set in the “virtual page number” field (i.e., in the move destination information for the deleted page), the page identification information corresponding to the page added into the second document data is set in the “move destination page” field. It is noted that the page identification information corresponding to the page added into the second document data is identical to the page identification information which is set in the “virtual page number” field in the associated record that has been added into the document table for the second document data in step S07.

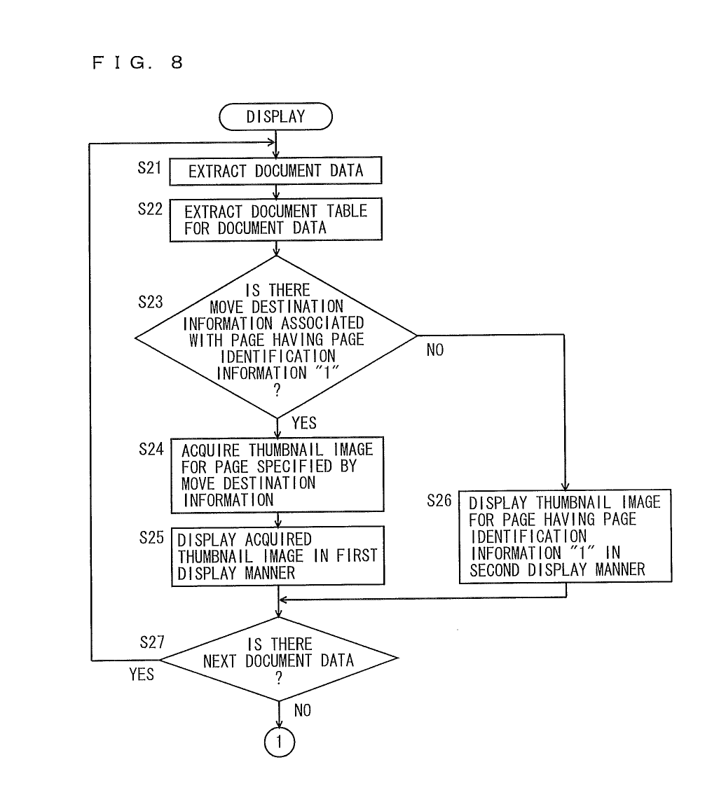

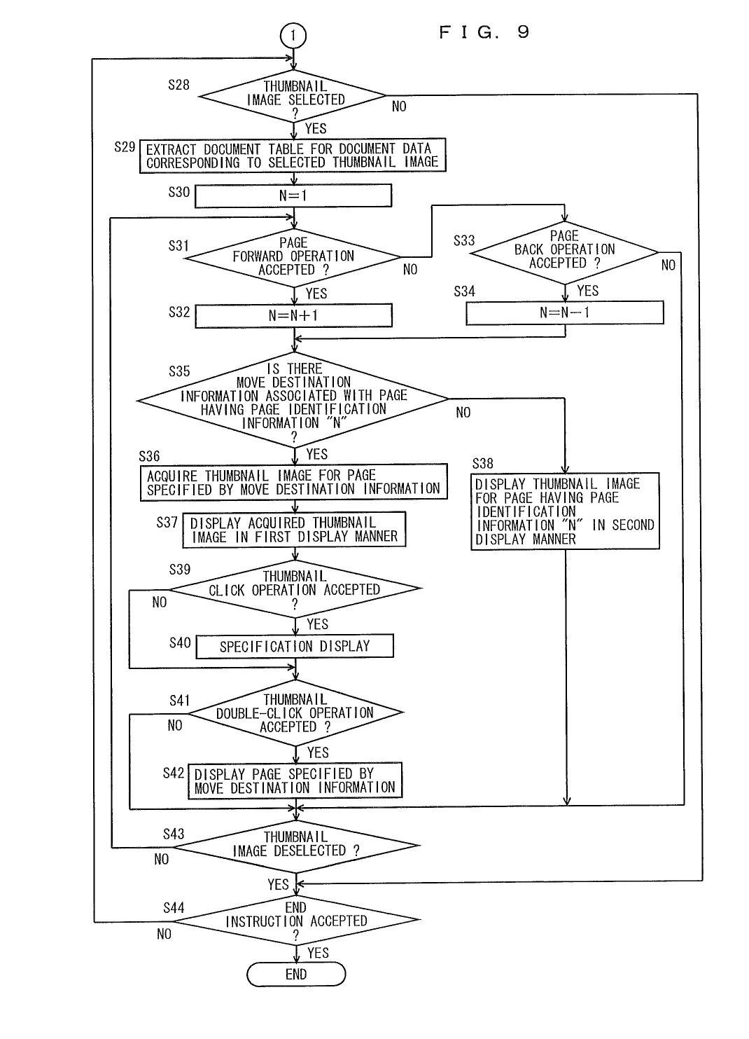

FIGS. 8 and 9 are flowcharts illustrating an example of the flow of a display process. The display process is carried out by CPU 101 as CPU 101 executes the document management program. Here, the case of displaying all the pieces of document data within a folder included in HDD 107 will be described.

Referring to FIG. 8, CPU 101 extracts one of a plurality of pieces of document data stored in HDD 107 as a process target (step S21). For example, when a user inputs into input portion 115 an instruction to display a list of all the pieces of document data within a folder, the plurality of pieces of document data stored in the folder are selected sequentially.

In the following step S22, a document table corresponding to the extracted document data is extracted from HDD 107. Then, in step S23, it is determined whether the document table extracted in step S22 includes move destination information in association with the page having the page identification information “1”. Specifically, CPU 101 extracts, from the extracted document table, an associated record having the page identification information “1” set in the “virtual page number” field, and determines whether the “move destination document” field and the “move destination page” field in the “move destination information” field in the extracted associated record are left blank. If the “move destination document” field and the “move destination page” field in the “move destination information” field are not blank, it is determined that the move destination information is associated with the page having the page identification information “1”, and the process proceeds to step S24. On the other hand, if the “move destination document” field and the “move destination page” field in the “move destination information” field are left blank, it is determined that the move destination information is not associated, and the process proceeds to step S26. Hereinafter, the document data in which the move destination information is set in association with the page having the page identification information “1” will be referred to as the “move source document data”.

In step S26, a thumbnail image for the page having the page identification information “1” is acquired from the document data extracted in step S21, and the acquired thumbnail image is displayed on display portion 117 in the second display manner. The process then proceeds to step S27. In this case, the page having the page identification information “1” is the first page in the document data extracted in step S21.

On the other hand, the process proceeds to step S24 when the page having the page identification information “1” is the page deleted from the document data (move source document data) extracted in step S21. In steps S24 and S25, a thumbnail image for the deleted page is acquired from the document data into which the deleted page has been added. Hereinafter, the document data into which the page deleted from the move source document data extracted in step S21 has been added will be referred to as the “move destination document data”.

In step S24, the thumbnail image for the page specified by the move destination information extracted in step S23 is acquired. Specifically, a document table corresponding to the document data (move destination document data) specified by the document identification information set in the “move destination document” field in the “move destination information” field in the associated record extracted in step S23 is extracted. Then, on the basis of the page identification information set in the “move destination page” field in the “move destination information” field in the associated record extracted in step S23 (hereinafter, referred to as the “relevant page information”), the thumbnail image for the page within the move destination document data corresponding to the page identification information that is identical to the relevant page information is acquired from the move destination document data. The page number of the page, within the move destination document data, that corresponds to the page identification information identical to the relevant page information is determined as follows. In the document table corresponding to the move destination document data, among the associated records in which the page identification information smaller in value than the page identification information identical to the relevant page information is set in the “virtual page number” field, the number of associated records having the “move destination information” field that is left blank is counted, and the count value is incremented by one. The resultant value is determined to be the page number of that page.

In step S25, the thumbnail image acquired in step S24 is displayed on display portion 117 in the first display manner, and the process proceeds to step S27. The first display manner is lower in brightness than the second display manner.

In step S27, it is determined whether there is another document data to be processed. If there is document data yet to be processed, the process returns to step S21; otherwise, the process proceeds to step S28. When the user inputs into input portion 115 an instruction to display a list of all the pieces of document data within a folder, the thumbnail image for the first page, or for the deleted first page, is displayed for each of the document data within the folder.

Referring next to FIG. 9, in step S28, it is determined whether an instruction to select a thumbnail image has been accepted. If the instruction to select a thumbnail image is accepted, the process proceeds to step S29; otherwise, the process proceeds to step S44. When the user operates the mouse to place the mouse pointer on a thumbnail image, the instruction to select the thumbnail image is accepted.

In step S29, a document table for the document data corresponding to the selected thumbnail image is extracted from HDD 107. Then, a variable N is set to “1” (step S30), and the process proceeds to step S31. For the variable N, the page identification information for the page to be displayed is set.

In step S31, it is determined whether a page forward operation has been accepted. When a user inputs into input portion 115 an operation to designate a page forward button, the page forward operation is accepted. If the page forward operation is accepted, the process proceeds to step S32; otherwise, the process proceeds to step S33. In step S32, the variable N is incremented by one, and the process proceeds to step S35.

In step S33, it is determined whether a page back operation has been accepted. If the page back operation is accepted, the process proceeds to step S34; otherwise, the process proceeds to step S43. When the user inputs into input portion 115 an operation to designate a page back button, the page back operation is accepted. In step S34, the variable N is decremented by one, and the process proceeds to step S35.

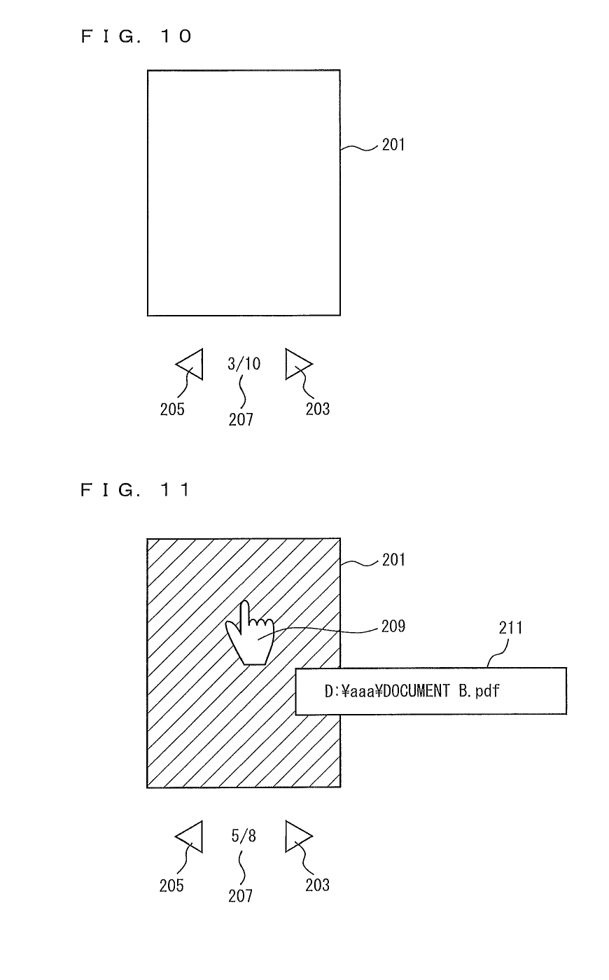

FIG. 10 illustrates a page forward button and a page back button. Referring to FIG. 10, a page forward button 203 and a page back button 205 are displayed below a thumbnail image 201. Provided between page forward button 203 and page back button 205 is an area 207 in which the page identification information for thumbnail image 201 and the total page count for the document data containing the page corresponding to thumbnail image 201 are displayed. In FIG. 10, the page identification information “3” for thumbnail image 201 and the total page count “10” are shown in area 207.

Returning to FIG. 9, in step S35, it is determined whether move destination information is associated with the page having the page identification information “N”. Specifically, from the associated records included in the document table extracted in step S29, the associated record in which the page identification information equal to the variable N is set in the “virtual page number” field is extracted. It is then determined whether the “move destination document” field and the “move destination page” field in the “move destination information” field in the extracted associated record are left blank. If those fields are not blank, it is determined that the move destination information is associated with the page having the page identification information “N”, and the process proceeds to step S36. If those fields are left blank, it is determined that the move destination information is not associated with the page, and the process proceeds to step S38. Hereinafter, the document data in which the move destination information is set in association with the page having the page identification information “N” will be referred to as the “move source document data”.

In step S38, a thumbnail image for the page having the page identification information “N” is acquired from the document data extracted in step S29, and the acquired thumbnail image is displayed on display portion 117 in the second display manner. The process then proceeds to step S43. The page number of the page having the page identification information “N” is determined as follows. In the document table corresponding to the document data extracted in step S29, among the associated records in which the page identification information smaller in value than the page identification information “N” is set in the “virtual page number” field, the number of associated records having the “move destination information” field that is left blank is counted, and the count value is incremented by one. The resultant value is determined to be the page number of that page.

On the other hand, the process proceeds to step S36 when the page having the page identification information “N” is the page deleted from the document data (move source document data) that was selected in accordance with selection of the thumbnail image in step S28. In steps S36 and S37, a thumbnail image for that deleted page is acquired from the document data to which the deleted page has been added. Here, the document data selected as a result of selection of the thumbnail image in step S28 is referred to as the “move source document data”, and the document data to which the deleted page has been added is referred to as the “move destination document data”.

In step S36, a thumbnail image for the page specified by the move destination information is acquired. Specifically, in the document table corresponding to the move source document data extracted in step S29, the associated record having the page identification information “N” set in the “virtual page number” field is extracted, and the document table corresponding to the document data (move destination document data) identified by the document identification information set in the “move destination document” field in the “move destination information” field in the extracted associated record is extracted. Then, on the basis of the page identification information set in the “move destination page” field in the “move destination information” field in the document table corresponding to the move source document data extracted in step S29 (hereinafter, referred to as the “relevant page information”), a thumbnail image for the page within the move destination document data which corresponds to the page identification information identical to the relevant page information is acquired from the move destination document data. The page number of the page, within the move destination document data, that corresponds to the page identification information identical to the relevant page information is determined as follows.

In the document table corresponding to the move destination document data, among the associated records in which the page identification information smaller in value than the page identification information identical to the relevant page information is set in the “virtual page number” field, the number of associated records having the “move destination information” field that is left blank is counted, and the count value is incremented by one. The resultant value is determined to be the page number of that page.

In step S37, the thumbnail image acquired in step S36 is displayed on display portion 117 in the first display manner, and the process proceeds to step S39. The first display manner is lower in brightness than the second display manner.

In step S39, it is determined whether an operation to click on the thumbnail image displayed in the first display manner in step S37 has been accepted. When the user operates the mouse included in input portion 115 to input an operation to click the mouse button once with the mouse pointer placed on the thumbnail image, the operation to click on the thumbnail image is accepted. If the operation to click on the thumbnail image is accepted, the process proceeds to step S40; otherwise, the process proceeds to step S41, with step S40 being skipped.

In step S40, a specification display is displayed. The specification display is a display for specifying the move destination document data into which the deleted page has been moved. The specification display can notify the user of the location of the deleted page which corresponds to the thumbnail image displayed in the first display manner.

Specifically, as the specification display, the document identification information for the move destination document data into which the deleted page has been moved may be displayed. Here, in the document table corresponding to the move source document data extracted in step S29, the associated record having the page identification information “N” set in the “virtual page number” field is extracted, and then, the document identification information set in the “move destination document” field in the “move destination information” field in the extracted associated record is displayed on display portion 117.

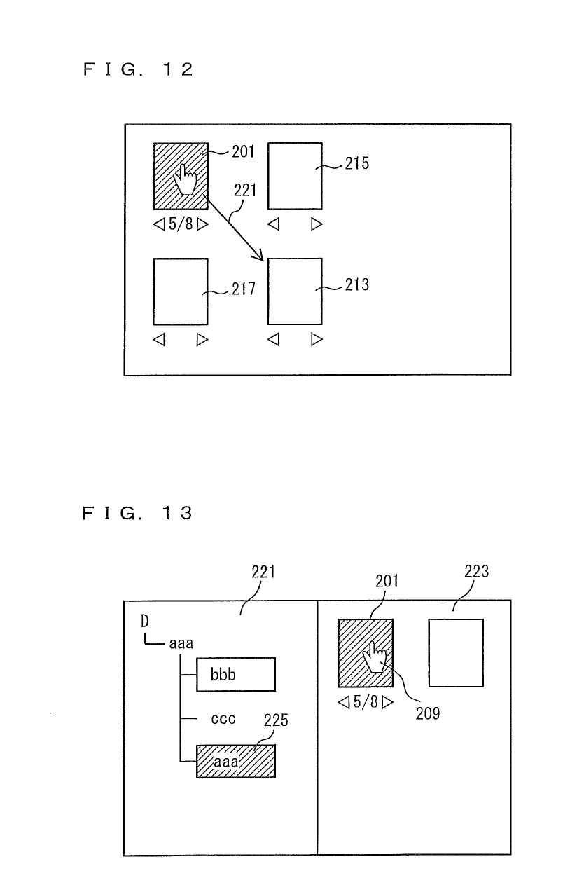

FIG. 11 is a first diagram showing an example of the specification display. FIG. 11 shows a thumbnail image 201 displayed in the first display manner and a field 211 in which document identification information is displayed. Field 211 as the specification display is displayed when a single-click operation is input in the state where a mouse pointer 209 is placed on thumbnail image 201.

Returning to FIG. 9, in step S41, it is determined whether an operation to double-click on the thumbnail image displayed in the first display manner in step S37 has been accepted. When the user operates the mouse included in input portion 115 to input an operation to click the mouse button twice consecutively with the mouse pointer placed on the thumbnail image, the operation to double-click on the thumbnail image is accepted. If the operation to double-click on the thumbnail image is accepted, the process proceeds to step S42; otherwise, the process proceeds to step S43, with step S42 being skipped.

In step S42, a page specified by the move destination information is displayed. That is, an actual status of the page corresponding to the thumbnail image displayed in the first display manner is displayed. Specifically, from the document table corresponding to the move source document data extracted in step S29, the associated record having the page identification information “N” set in the “virtual page number” field is extracted. Then, the document data (move destination document data) identified by the document identification information set in the “move destination document” field in the “move destination information” field in the extracted associated record is opened by starting the corresponding application program. Meanwhile, the page identification information that is set in the “move destination page” field in the previously extracted associated record (i.e., the associated record included in the document table corresponding to the move source document data and having “N” set in the “virtual page number” field) is preset as “target page identification information”. Then, in the document table corresponding to the move destination document data, the page number of the page corresponding to that target page identification information is determined, and the page having the determined page number among the pages included in the move destination document data is displayed. The page number of the page corresponding to the target page identification information is determined as follows. In the document table corresponding to the move destination document data, among the associated records in which the page identification information smaller in value than the target page identification information is set in the “virtual page number” field, the number of associated records having the “move destination information” field that is left blank is counted, and the count value is incremented by one. The resultant value is determined to be the page number of that page.

In step S43, it is determined whether the thumbnail image selected in step S28 has been deselected. Specifically, it is determined whether the user has operated input portion 115 to input an operation to deselect the thumbnail image. If the operation to deselect the thumbnail image is accepted, the process proceeds to step S44; otherwise, the process returns to step S31. In step S44, it is determined whether an end instruction has been accepted. If the end instruction is accepted, the process is terminated; otherwise, the process returns to step S28 to allow the user to select a next thumbnail image.

### <First Modification of Specification Display>

The specification display described above is a display of document identification information. According to a first modification, an arrow is displayed as the specification display. FIG. 12 shows the first modification of the specification display. Referring to FIG. 12, an example of a list display screen is shown, in which a thumbnail image 201 is displayed in the first display manner, and a plurality of thumbnail images 213, 215, and 217 are also displayed. When a single-click operation with the mouse pointer placed on thumbnail image 201 is accepted, an arrow 221 as the specification display is displayed. Arrow 221 extends from thumbnail image 201 to thumbnail image 213, with thumbnail image 201 as its starting point and thumbnail image 213 as its ending point. Here, thumbnail image 213 represents the move destination document data to which the page has been moved. This modification is effective in the case where the thumbnail image representing the move source document data in which the page was originally included and the thumbnail image representing the move destination document data to which the page has been moved are displayed in the same screen.

### <Second Modification of Specification Display>

A second modification of the specification display is effective in the case where the move source document data in which the page was originally included and the move destination document data to which the page has been moved are stored in separate folders. Here, it is assumed that the move source document data in which the page was included before being moved is stored in a folder named “bbb” and the move destination document data to which the page has been moved is stored in a folder named “aaa”.

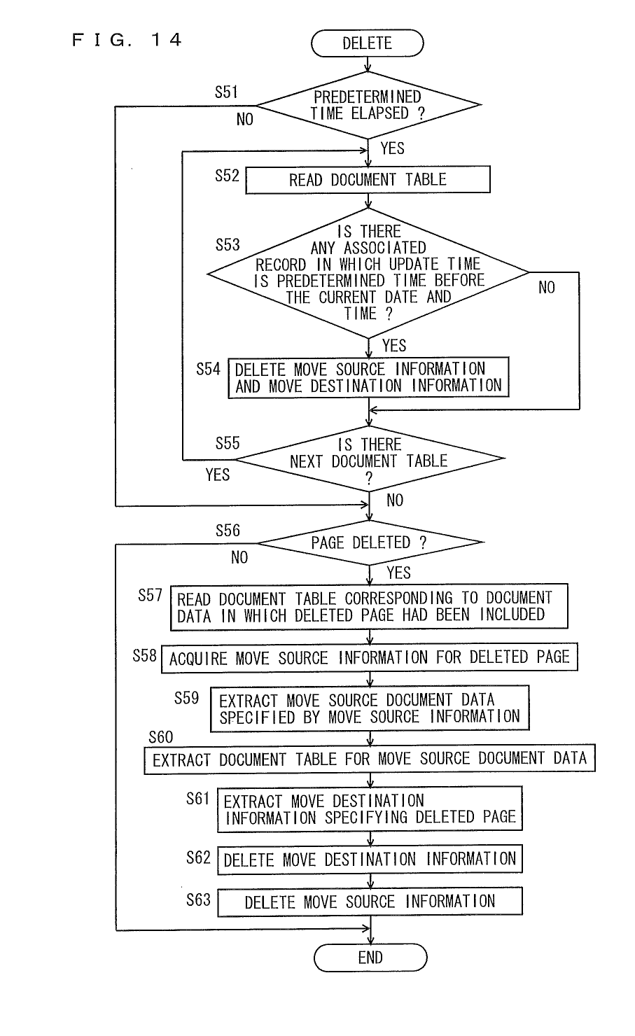

FIG. 13 shows the second modification of the specification display. Referring to FIG. 13, a screen includes an area 223 in which the content of a first folder is shown, and an area 221 in which the folder configuration is shown. FIG. 13 shows the case where the move source document data in which the page was included before being moved is stored in the folder “bbb”, and thumbnail images corresponding to the document data stored in the folder “bbb” are displayed in area 223. In area 221, the names of the folders “bbb”, “ccc”, and “aaa” are displayed. When a single-click operation with the mouse pointer placed on thumbnail image 201 being displayed in area 223 in the first display manner is accepted, the folder name “aaa” being displayed in area 221 as the specification display is displayed in a color different from that for the other folder names. For example, while the other folder names are displayed in black, the folder name “aaa” is displayed in red.

While the PC has been described as an example of the document management system in the above embodiment, the document management system may have a plurality of PCs, used by different persons, and a file server, storing document data and document tables, which are connected via a network such as a LAN. In this case, the document data and the document tables are stored in the file server, and in accordance with an operation input by a user into a PC, the page editing process of updating the document data and the document tables is carried out in the PC or in the file server, and the display process of displaying the document data is carried out in the PC with reference to the document tables stored in the file server.

FIG. 14 is a flowchart illustrating an example of the flow of a deleting process. The deleting process is carried out by CPU 101 as CPU 101 executes the document management program. Referring to FIG. 14, CPU 101 determines whether a predetermined time has elapsed (step S51). If the predetermined time has elapsed, the process proceeds to step S52; otherwise, the process proceeds to step S56. In other words, steps S52 through S55 are carried out at the predetermined time intervals. In step S52, one of a plurality of document tables stored in HDD 107 is read. Then, it is determined whether the associated records included in the read document table include any associated record in which the date and time being set in the “update time” field indicates the predetermined time before the current date and time (step S53).

If there is the associated record in which the date and time set therein indicates the predetermined time before the current date and time, the process proceeds to step S54; otherwise, the process proceeds to step S55. In step S54, the move source information and the move destination information are deleted, and the process proceeds to step S55. Specifically, in the associated record in which the date and time the predetermined time before the current date and time is set, the “move source information” field and the “move destination information” field are made blank. In the case where the move destination information is deleted, the associated record itself may be deleted. In this case, the page identification information is changed, and therefore, it is necessary to change the move destination information in the document table corresponding to the document data that is specified by the move source information of which the page identification information has been changed, as described above in conjunction with steps S09 to S14 in FIG. 7. Here, description of the process will not be repeated.

In step S55, it is determined whether a document table yet to be processed is stored in HDD 107. If there is a document table yet to be processed, the process returns to step S52; otherwise, the process proceeds to step S56.

In step S56, it is determined whether a page has been deleted. If a page has been deleted, the process proceeds to step S57; otherwise, the process is terminated. In step S57, the document table corresponding to the document data in which the deleted page was included is read from HDD 107.

In the following step S58, the move source information of the deleted page is acquired. Specifically, from the associated records included in the document table read in step S57, the associated record in which the page identification information corresponding to the deleted page is set in the “virtual page number” field is extracted, and the document identification information set in the “move source document” field in the “move source information” field in the extracted associated record is acquired.

Then, the move source document data specified by the acquired document identification information is extracted (step S59). In the following step S60, the document table for the move source document data is extracted. Further, from the extracted document table for the move source document data, the move destination information specifying the deleted page is extracted (step S61). Specifically, from the plurality of associated records included in the document table for the move source document data, the associated record in which the document identification information for identifying the document data including the deleted page is set in the “move destination document” field and the page identification information corresponding to the deleted page is set in the “move destination page” field in the “move destination information” field is extracted.

In the following step S62, the move destination information is deleted. Specifically, in the associated record extracted in step S61, the “move destination document” field and the “move destination page” field in the “move destination information” field are made blank, to thereby delete the move destination information. In the following step S63, the move source information is deleted. Specifically, among the plurality of associated records included in the document table read in step S57, in the associated record in which the page identification information corresponding to the deleted page is set in the “virtual page number” field, the “move source document” field is made blank.

As described above, according to PC 100 serving as the document management system in the present embodiment, when at least one of the pages included in first document data selected from among a plurality of pieces of document data stored in HDD 107 is moved to second document data which is different from the first document data, move destination information is stored in a document table for the first document data in such a manner that the move destination information is associated with page identification information which is included in the document table for the first document data and which identifies the page that had been included in the first document data before movement of the page and that has been deleted therefrom as a result of the movement of the page. The move destination information includes document identification information for identifying the second document data and page identification information for identifying the page that has been added to the second document data as a result of the movement of the page.

Accordingly, the document data into which the deleted page has been added as well as the position of the page within that document data can be specified on the basis of the move destination information. Therefore, even in the case where a page is deleted from document data, it is possible to track the page deleted from the document data.

Furthermore, move source information including the document identification information for identifying the first document data is stored in a document table for the second document data in such a manner that the move source information is associated with page identification information which is included in the document table for the second document data and which identifies the page that has been added to the second document data as a result of the movement of the page. When the page identification information for the page specified by the move destination information is changed, the page identification information included in the move destination information is updated with the changed page identification information. Therefore, even in the case where the page order is changed within the second document data due to a page added thereto, the move destination information included in the document table for the first document data can be updated correspondingly.

The date and time when the page was deleted and added is stored together with the move destination information and the move source information, and when a predetermined time has passed from the date and time stored together with the move destination information and the move source information, the move destination information and the move source information are deleted. As the move destination information and the move source information are deleted a predetermined time after deletion and addition of the page, it is possible to allow tracking of the deleted page only during the predetermined time. The track that is no longer necessary after a lapse of the predetermined time can be prevented from being displayed.

In response to the event that the page specified by the move destination information is erased, the move destination information is deleted. This prevents the erased page from being tracked in vain.

Furthermore, the thumbnail image for the page deleted from the document data is displayed in the first display manner, while the thumbnail image for the page included in the document data is displayed in the second display manner, in accordance with the document table stored in HDD 107. This can notify the user of the page that has been deleted from the document data. Moreover, as the thumbnail image for the page included in the document data and the thumbnail image for the deleted page are displayed in different display manners, the user can visually recognize whether the page has been deleted or not.

When a first operation to click the mouse on the thumbnail image being displayed in the first display manner is input, the document identification information for the document data specified by the move destination information is displayed (“specification display”). This allows the user to readily specify the document into which the deleted page has been added.

When a second operation to double-click the mouse on the thumbnail image being displayed in the first display manner is input, the page specified by the move destination information is displayed. This allows the user to readily confirm the deleted page.

As described above, according to PC 100 of the present embodiment, the move destination information is determined only by the document data as a move source and document data as a move destination. More specifically, even in the case where a certain page is moved from one document to another document over a large number of generations, such iterations of the page move operations will not affect the move destination information stored for the document data of two or more generations before (i.e., the document data preceding the move source document data). For example, in the case where a certain page Y that was originally included in document data M is moved into document data N and then moved into document O, the move destination information included in document M is kept as “document N”; only the move destination information included in document N is changed to “document O”. Therefore, even for the page that is moved from one document to another document over a large number of generations, it is possible to confirm the ultimate move destination of the page by following the move destination information stored for the document data in each generation as appropriate.

While PC 100 has been described as an example of the document management system in the above embodiment, the present invention may of course be understood as a document management method for performing the processes shown in FIGS. 7 to 9 and 14, or a document management program for causing a computer to perform the document management method.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A document management system comprising:
a document data storing portion to store a plurality of pieces of document data each including at least one page;
a selecting portion to select first document data and second document data that is different from said first document data from among said plurality of pieces of stored document data;
a moving portion to move at least one page among the at least one page included in said selected first document data into said selected second document data; and
a move destination storing portion to store move destination information, in correspondence with a page that had been included in said first document data before movement of the page and that has been deleted from said first document data and added into said second document data as a result of the movement of the page, to indicate that the page that had been included in said first document data before movement of the page has been deleted from said first document data and added into said second document data.

2. The document management system according to claim 1, further comprising a move source storing portion to store move source information, in correspondence with a page that had not been included in said second document data before movement of the page and that has been added into said second document data from said first document data as a result of the movement of the page, to indicate that the page has been added from said first document data as a result of the movement of the page.

3. The document management system according to claim 2, wherein
said move destination storing portion stores the move destination information including document identification information for identifying said second document data and page identification information for identifying the page that has been added into said second document data as a result of the movement of the page, in association with said first document data and page identification information for identifying the page that had been included in said first document data before the movement of the page and that has been deleted from said first document data as a result of the movement of the page, and
said move source storing portion stores the move source information including document identification information for identifying said first document data, in association with said second document data and page identification information for identifying the page that has been added into said second document data as a result of the movement of the page.

4. The document management system according to claim 3, further comprising a document table storing portion to store a plurality of document tables corresponding respectively to said plurality of pieces of stored document data, wherein
each of said plurality of document tables includes page identification information for identifying each of the at least one page that is included in the corresponding document data among said plurality of pieces of stored document data and any page that has been deleted from the document data,
said move destination storing portion stores said move destination information in the document table corresponding to said first document data, in such a manner that said move destination information is associated with page identification information which is included in the document table corresponding to said first document data and which is for identifying the page that had been included in said first document data before the movement of the page and that has been deleted from said first document data as a result of the movement of the page, and
said move source storing portion stores said move source information in the document table corresponding to said second document data, in such a manner that said move source information is associated with page identification information which is included in the document table corresponding to said second document data and which is for identifying the page that has been added into said second document data as a result of the movement of the page.

5. The document management system according to claim 4, further comprising a display control portion to display a page deleted from any of said plurality of pieces of document data, on the basis of said plurality of document tables.

6. The document management system according to claim 3, further comprising an updating portion, in response to an event that the page identification information for the page specified by said move destination information is changed, to update said page identification information included in said move destination information with the changed page identification information.

7. The document management system according to claim 2, wherein said move destination storing portion and said move source storing portion store a date and time when the page was deleted and added, together with said move destination information and said move source information,
the document management system further comprising a deleting portion to delete said move destination information and said move source information when a predetermined time has elapsed from the date and time stored together with said move destination information and said move source information.

8. The document management system according to claim 1, further comprising a deleting portion to delete said move destination information in response to an event that the page specified by said move destination information is erased.

9. A document management system comprising:
a document data storing portion to store a plurality of pieces of document data each including at least one page; and
a document table storing portion to store a plurality of document tables corresponding respectively to said plurality of pieces of stored document data, each document table including page identification information for identifying each of the at least one page that is included in the corresponding document data among said plurality of pieces of stored document data and any page that has been deleted from the document data.

10. The document management system according to claim 9, further comprising:
a selecting portion to select first document data and second document data that is different from said first document data from among said plurality of pieces of stored document data;
a moving portion to move at least one page among the at least one page included in said selected first document data into said selected second document data;
a move destination storing portion to store move destination information including document identification information for identifying said second document data and page identification information for identifying a page added into said second document data as a result of movement of the page, the move destination information being stored in the document table corresponding to said first document data in such a manner that said move destination information is associated with page identification information which is included in the document table corresponding to said first document data and which is for identifying the page that had been included in said first document data before the movement of the page and that has been deleted from said first document data as a result of the movement of the page; and
a move source storing portion to store move source information including document identification information for identifying said first document data, the move source information being stored in the document table corresponding to said second document data in such a manner that said move source information is associated with page identification information which is included in the document table corresponding to said second document data and which is for identifying the page that has been added into said second document data as a result of the movement of the page.

11. The document management system according to claim 10, further comprising an updating portion, in response to an event that the page identification information for the page specified by said move destination information is changed, to update said page identification information included in said move destination information with the changed page identification information.

12. The document management system according to claim 10, wherein said move destination storing portion and said move source storing portion store a date and time when the page was deleted and added, together with said move destination information and said move source information,
the document management system further comprising a deleting portion to delete said move destination information and said move source information when a predetermined time has elapsed from the date and time stored together with said move destination information and said move source information.

13. The document management system according to claim 10, further comprising a deleting portion to delete said move destination information in response to an event that the page specified by said move destination information is erased.

14. The document management system according to claim 9, further comprising a display control portion to display a page deleted from any of said plurality of pieces of document data, on the basis of said plurality of document tables, wherein
said display control portion includes a thumbnail display portion to display a thumbnail image which is an image reduced in size of the page specified by said page identification information.

15. The document management system according to claim 9, further comprising a display control portion to display a page deleted from any of said plurality of pieces of document data, on the basis of said plurality of document tables, the display control portion including
an extracting portion to extract one of said plurality of stored document tables corresponding to one of said plurality of pieces of document data,
a page selecting portion to sequentially select at least one piece of page identification information included in said extracted document table, and
a thumbnail display portion to display a thumbnail image which is an image reduced in size of the page specified by said selected page identification information, the thumbnail display portion including
a first manner display portion, in the case where said move destination information associated with said selected page identification information by said extracted document table includes document identification information and page identification information, to display a thumbnail image for the page specified by the document identification information and the page identification information in a first display manner, and
a second manner display portion, in the case where said move destination information is not associated with said selected page identification information, to display a thumbnail image for the page specified by the page identification information in a second display manner which is different from said first display manner.

16. The document management system according to claim 15, further comprising a move destination specification display portion to display a specification display for specifying the document data specified by said move destination information in response to an event that a first operation is performed with respect to the thumbnail image displayed in the first display manner by said thumbnail display portion.

17. The document management system according to claim 16, wherein as said specification display, said move destination specification display portion displays the thumbnail image for the document data specified by said move destination information in a display manner different from a display manner for another thumbnail image.

18. The document management system according to claim 16, wherein as said specification display, said move destination specification display portion displays an arrow which extends from the thumbnail image for said selected document data toward the thumbnail image for the document data specified by said move destination information.

19. The document management system according to claim 16, wherein as said specification display, said move destination specification display portion displays document identification information for identifying the document data specified by said move destination information.

20. The document management system according to claim 15, further comprising an actual-status page display portion to display the page specified by said move destination information in response to an event that a second operation is performed with respect to the thumbnail image displayed in the first display manner by said thumbnail display portion.

21. A document management method, comprising the steps of:
selecting first document data from among a plurality of pieces of stored document data each including at least one page;
selecting second document data that is different from said first document data from among said plurality of pieces of stored document data;
moving at least one page among the at least one page included in said first document data into said second document data; and
storing move destination information, in correspondence with a page that had been included in said first document data before movement of the page and that has been deleted from said first document data and added into said second document data as a result of the movement of the page, to indicate that a page that had been included in said first document data before movement of the page has been deleted from said first document data and added into said second document data.

22. A document management method, comprising the steps of:
storing a plurality of document tables corresponding respectively to a plurality of pieces of stored document data each including at least one page, each document table including page identification information for identifying each of the at least one page that is included in the corresponding document data among said plurality of pieces of stored document data and any page that has been deleted from the document data; and
displaying a page deleted from any of said plurality of pieces of document data, on the basis of said plurality of document tables.

23. A document management program embodied on a computer readable medium, the program causing a computer to perform the steps of:
selecting first document data from among a plurality of pieces of stored document data each including at least one page;
selecting second document data that is different from said first document data from among said plurality of pieces of stored document data;
moving at least one page among the at least one page included in said first document data into said second document data; and
storing move destination information, in correspondence with a page that had been included in said first document data before movement of the page and that has been deleted from said first document data and added into said second document data as a result of the movement of the page, to indicate that the page that had been included in said first document data before movement of the page has been deleted from said first document data and added into said second document data.

24. A document management program embodied on a computer readable medium, the program causing a computer to perform the steps of:
storing a plurality of document tables corresponding respectively to a plurality of pieces of stored document data each including at least one page, each document table including page identification information for identifying each of the at least one page that is included in the corresponding document data among said plurality of pieces of stored document data and any page that has been deleted from the document data; and
displaying a page deleted from any of said plurality of pieces of document data, on the basis of said plurality of document tables.
